(19) United States
(12) Patent Application Publication
(10) Pub. No.: US 2008/0005553 A1
(43) Pub. Date: Jan. 3, 2008

(54) BIOS updating method and apparatus thereof

(75) Inventor: Chin-Yu Wang, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/808,479

(22) Filed: Jun. 11, 2007

(30) Foreign Application Priority Data
Jun. 12, 2006 (TW) 95120843

(51) Int. Cl. G06F 9/00

(52) U.S. Cl. 713/2

(57) ABSTRACT

A BIOS updating method includes the following steps: First, a BIOS image file is divided into a plurality of BIOS files. Then, at least one BIOS updating file is inserted into the BIOS files or is substituted for one of the BIOS files to provide a plurality of updated BIOS files. Finally, the updated BIOS files are packaged to provide an updated image file.

### RELATED APPLICATIONS

This application claims priority to Taiwan Application Serial Number 95120843, filed Jun. 12, 2006, which is herein incorporated by reference.

### BACKGROUND

1. Field of Invention

The present invention relates to a basic input and output system (BIOS) maintenance method. More particularly, the present invention relates to a BIOS updating method.

2. Description of Related Art

With advances in the fabrication of electronic components and computer systems, a large variety of computer devices are becoming increasingly available to the public. Besides well known personal computers, portable electronic devices equipped with specific functionalities, such as MP3 players, digital cameras, portable phones and personal digital assistants (PDAs), etc., are seen as a kind of computer systems.

In most computer systems, system BIOS controls input units and output units. The BIOS initializes input units and output units of a computer system when the computer system boots. Hence, along with an increase in the amount and the enhancement of the functions of the input units and the output units of the computer system, the BIOS sometimes needs to be updated to control these input units and output units of the computer system. Therefore, the BIOS is often stored in a re-writable non-volatile memory, such as a flash memory, so it can be updated easily.

A traditional BIOS updating method includes the following steps: First, the last version BIOS image file is downloaded from the internet. Then, the last version BIOS image file is substituted for the original BIOS. However, the size of the BIOS image file is usually larger than 1 MB, and hence the step of downloading the whole BIOS image file is time-consuming and frustrating. Actually, only a part of the BIOS, such as the logo component or the central processing unit (CPU) microcode, need to be updated. Therefore, downloading the whole BIOS image file to update the part of the BIOS is not only time-consuming but inefficient.

For the forgoing reasons, there is a need for a solution to solve the mentioned problems.

### SUMMARY

In accordance with the foregoing and other aspects of the present invention, a BIOS updating method is provided. The BIOS updating method includes the following steps: First, a BIOS image file is divided in to a plurality of BIOS files. Then, at least one BIOS updating file is inserted into the BIOS files or is substituted for one of the BIOS files to provide a plurality of updated BIOS files. Finally, the updated BIOS files are packaged to provide an updated image file.

The invention provides a BIOS updating apparatus for a computer as well. The BIOS updating apparatus includes a dividing module, a substituting module and a packaging module. The dividing module is used to divide a BIOS image file into a plurality of BIOS files. The substituting module is electrically connected to the dividing module to insert at least one BIOS updating file into the BIOS files or substitute the BIOS updating file for at least one of the BIOS files to provide a plurality of updated BIOS files. The packaging module is electrically connected to the substituting module to package the updated BIOS files to provide an updated image file.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a flow chart illustrating a BIOS updating method according to one preferred embodiment of the present invention;

FIG. 1B is a flow chart illustrating a BIOS updating method according to another preferred embodiment of the present invention;

FIG. 2A is a functional block diagram showing a BIOS updating apparatus according to one preferred embodiment of the present invention; and

FIG. 2B is a functional block diagram showing a BIOS updating apparatus according to another preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

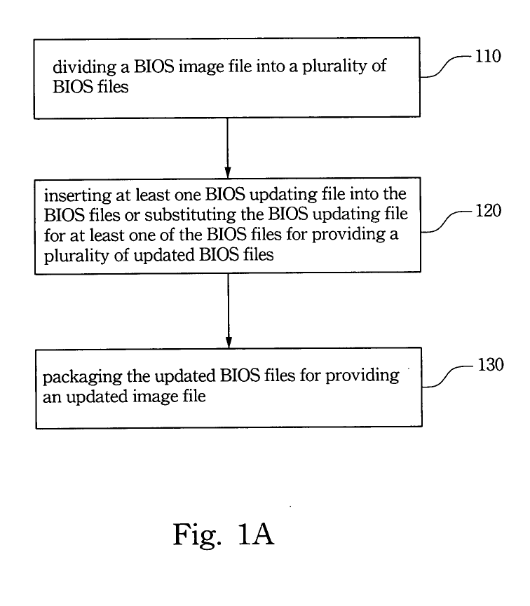

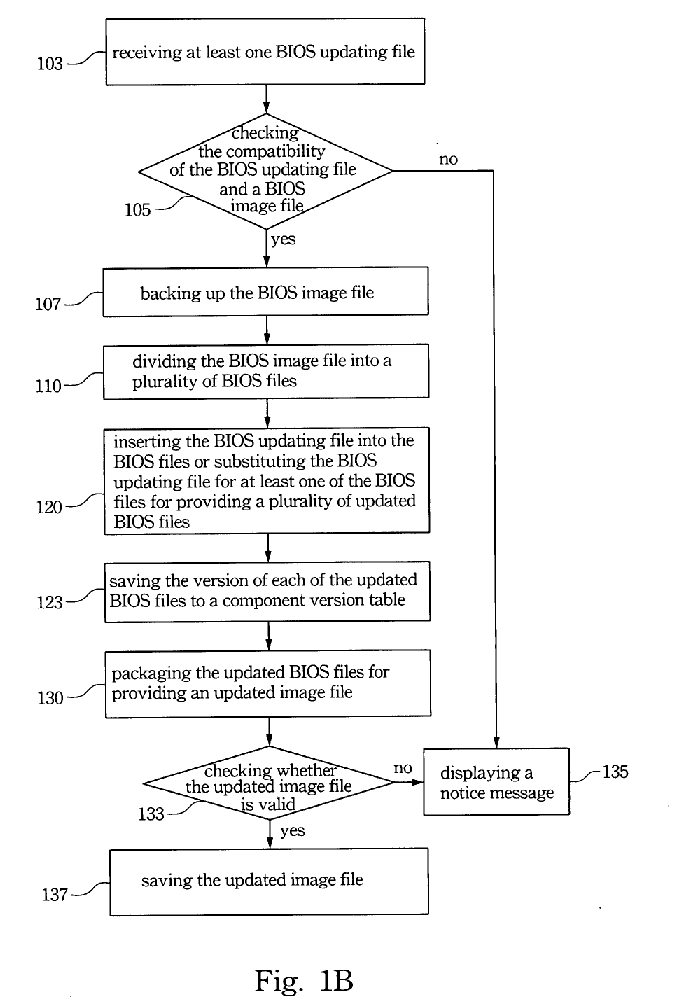

Refer to FIG. 1A. FIG. 1A is a flow chart illustrating a BIOS updating method according to one preferred embodiment of the present invention. As shown in FIG. 1A, the BIOS updating method includes the following steps: First, a BIOS image file is divided in to a plurality of BIOS files (step 110). Then, at least one BIOS updating file is inserted into the BIOS files or is substituted for one of the BIOS files to provide a plurality of updated BIOS files (step 120). Finally, the updated BIOS files are packaged to provide an updated image file (step 120).

In other words, the BIOS updating method according to the present embodiment only updates the part of the BIOS image file which needs to be updated. Therefore, users no longer have to download the whole BIOS image file when updating the BIOS. Instead, the users can download the BIOS updating file only to update the part of the BIOS image file, which means time required to download files from the internet can be substantially reduced.

Refer to FIG. 1B. FIG. 1B is a flow chart illustrating a BIOS updating method according to another preferred embodiment of the present invention. As shown in FIG. 1B, the version of each of the updated BIOS files is saved to a component version table after the updated BIOS files are provided (step 123). Accordingly, a preceding compatibility checking step according to the component version table may be performed when the users update the BIOS the next time.

More specifically, the BIOS updating file may be received before the BIOS image file is divided (step 103). For example, the BIOS updating file is downloaded from the internet. Then, the compatibility of the BIOS updating file and the BIOS image file is checked before the BIOS image file is divided (step 105). That is, the component version table saved by a preceding BIOS updating process can be used to check whether the BIOS updating file is compatible with the BIOS image file. The step of dividing the BIOS image file and its following steps are performed when the BIOS updating file is compatible with the BIOS image file. On the other hand, a notice message is displayed when the BIOS updating file is not compatible with the BIOS image file (step 135).

In order to prevent the computer from being broken due to compatibility or other issues after updating the BIOS, the BIOS image file may be backed up first when the BIOS updating file is compatible with the BIOS image file (step 107), and then the step of dividing the BIOS image file and its following steps are performed. Accordingly, even if the BIOS is broken by a failed BIOS updating process, users can still restore the computer by recalling the BIOS image file saved by the step 107.

Furthermore, whether the updated image file is valid may be checked after the updated BIOS files are packaged (step 133). The updated image file is saved to the re-writable non-volatile memory of the computer when the updated image file is valid (step 137). On the other hand, a notice message is displayed when the updated image file is not valid (step 135). Accordingly, the computer can be protected well, that is, an invalid updated image file can be prevented from being saved to the re-writable non-volatile memory of the computer, which may cause the computer to be unworkable.

In addition, the step of inserting the BIOS updating file into the BIOS files or substituting the BIOS updating file for at least one of the BIOS files (step 120) may be used to substitute the BIOS updating file for a CPU micro code and/or a logo component of the BIOS files. However, this should not limit the present invention, and the component of the BIOS files replaced in this step should depend on actual requirements.

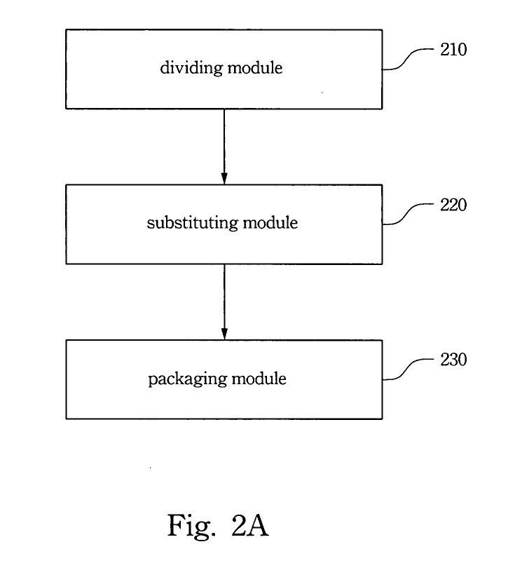

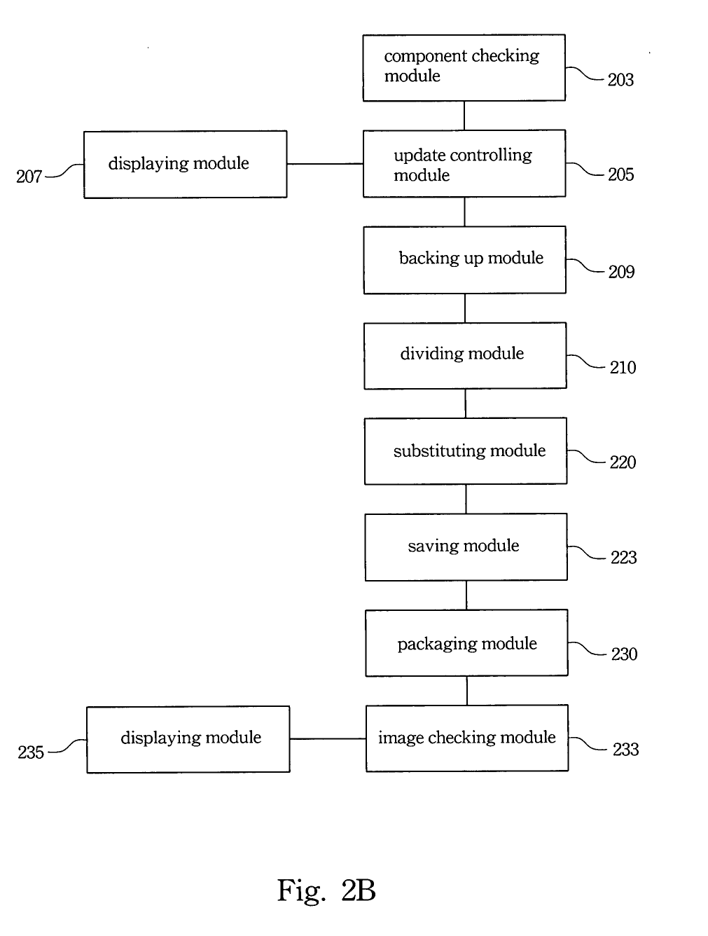

Refer to FIG. 2A. FIG. 2A is a functional block diagram showing a BIOS updating apparatus according to one preferred embodiment of the present invention. As shown in FIG. 2A, a BIOS updating apparatus includes a dividing module 210, a substituting module 220 and a packaging module 230. The dividing module 210 is used to divide a BIOS image file into a plurality of BIOS files. The substituting module 220 is electrically connected to the dividing module 210 to insert at least one BIOS updating file into the BIOS files or substitute the BIOS updating file for at least one of the BIOS files to provide a plurality of updated BIOS files. The packaging module 230 is electrically connected to the substituting module 220 to package the updated BIOS files to provide an updated image file.

Similarly, the BIOS updating apparatus according to the present embodiment only updates the part of the BIOS image file which needs to be updated. Therefore, users no longer have to download the whole BIOS image file when updating the BIOS. Instead, the users can download the BIOS updating file only to update the part of the BIOS image file, which means time required to download files from the internet can be substantially reduced.

Refer to FIG. 2B. FIG. 2B is a functional block diagram showing a BIOS updating apparatus according to another preferred embodiment of the present invention. As shown in FIG. 2B, a saving module 223 is electrically connected to the substituting module 220 and the packaging module 230 to save the version of each of the updated BIOS files to a component version table. Accordingly, a preceding compatibility checking step according to the component version table may be performed when the users update the BIOS the next time.

More specifically, the BIOS updating file may be received before the BIOS image file is divided. For example, the BIOS updating file is downloaded from the internet. Then, a component checking module 203 is electrically connected to the dividing module 210 for checking the compatibility of the BIOS updating file and the BIOS image file before the BIOS image file is divided. That is, the component checking module 203 may consult with the component version table saved by a preceding BIOS updating process to check whether the BIOS updating file is compatible with the BIOS image file.

Moreover, an update controlling module 205 may be electrically connected to the component checking module 203 and the dividing module 210 to allow the dividing module 210 to divide the BIOS image file only when the BIOS updating file is compatible with the BIOS image file. In addition, a displaying module 207 may also be electrically connected to the update controlling module 205 to display a notice message, showing the users that those two BIOS versions are not compatible, when the BIOS updating file is not compatible with the BIOS image file.

Similarly, in order to prevent the computer from being broken due to compatibility or other issues after updating the BIOS, a backing up module 209 may be electrically connected to the update controlling module 205 to back up the BIOS image file when the BIOS updating file is compatible with the BIOS image file. Accordingly, even if the BIOS is broken by a failed BIOS updating process, users can still restore the computer by recalling the BIOS image file saved by the backing up module 209.

Furthermore, an image checking module 233 may be electrically connected to the packaging module 230 to check whether the updated image file is valid after the updated BIOS files are packaged. In addition, a displaying module 235 may also be electrically connected to the image checking module 233 to display a notice message when the updated image file is not valid. Accordingly, the computer can be protected well, that is, an invalid updated image file can be prevented from being saved to the re-writable non-volatile memory of the computer, which may cause the computer to be unworkable.

In conclusion, the invention has at least the following advantages:

(1) The BIOS updating method or apparatus according to the mentioned embodiments only update the part of the BIOS image file which needs to be updated. Therefore, users no longer have to download the whole BIOS image file when updating the BIOS. Instead, users can download the BIOS updating file only to update the part of the BIOS image file, which means time required to download files from the internet can be substantially reduced.

(2) The BIOS updating method or apparatus according to the mentioned embodiments checks the compatibility before inserting or substituting the BIOS updating file. Therefore, the BIOS updating method or apparatus according the mentioned embodiments can prevent the computer from being unworkable.

(3) The BIOS updating method or apparatus according to the mentioned embodiments backs up the BIOS image file before inserting or substituting the BIOS updating file. Hence, even if the BIOS is broken by a failed BIOS updating process, users can still recall the original BIOS image file to restore the computer.

(4) The BIOS updating method or apparatus according to the mentioned embodiments checks whether the updated image file is valid after the updated BIOS files are packaged. Hence, the computer can be protected well by the BIOS updating method or apparatus according to the mentioned embodiments, that is, an invalid updated image file can be prevented from being saved to the re-writable non-volatile memory of the computer, which may cause the computer to be unworkable.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A BIOS updating method for a computer, comprising the steps of:
dividing a BIOS image file into a plurality of BIOS files;
inserting at least one BIOS updating file into the BIOS files or substituting the BIOS updating file for at least one of the BIOS files for providing a plurality of updated BIOS files; and
packaging the updated BIOS files for providing an updated image file.

2. The BIOS updating method of claim 1, further comprising the step of:
saving the version of each of the updated BIOS files to a component version table.

3. The BIOS updating method of claim 1, further comprising the step of:
checking the compatibility of the BIOS updating file and the BIOS image file before the BIOS image file is divided.

4. The BIOS updating method of claim 3, wherein the BIOS image file is divided when the BIOS updating file is compatible with the BIOS image file.

5. The BIOS updating method of claim 3, further comprising the step of:
displaying a notice message when the BIOS updating file is not compatible with the BIOS image file.

6. The BIOS updating method of claim 3, further comprising the step of:
backing up the BIOS image file when the BIOS updating file is compatible with the BIOS image file.

7. The BIOS updating method of claim 1, further comprising the step of:
checking whether the updated image file is valid after the updated BIOS files are packaged.

8. The BIOS updating method of claim 7, further comprising the step of:
displaying a notice message when the updated image file is not valid.

9. The BIOS updating method of claim 1, wherein the step of inserting the BIOS updating file into the BIOS files or substituting the BIOS updating file for at least one of the BIOS files for providing the updated BIOS files comprising:
substituting the BIOS updating file for a CPU micro code of the BIOS files.

10. The BIOS updating method of claim 1, wherein the step of inserting the BIOS updating file into the BIOS files or substituting the BIOS updating file for at least one of the BIOS files for providing the updated BIOS files comprising:
substituting the BIOS updating file for a logo component of the BIOS files.

11. A BIOS updating apparatus for a computer, comprising:
a dividing module for dividing a BIOS image file into a plurality of BIOS files;
a substituting module electrically connected to the dividing module for inserting at least one BIOS updating file into the BIOS files or substituting the BIOS updating file for at least one of the BIOS files for providing a plurality of updated BIOS files; and
a packaging module electrically connected to the substituting module for packaging the updated BIOS files for providing an updated image file.

12. The BIOS updating apparatus of claim 11, further comprising:
a saving module electrically connected to the substituting module and the packaging module for saving the version of each of the updated BIOS files to a component version table.

13. The BIOS updating apparatus of claim 11, further comprising:
a component checking module electrically connected to the dividing module for checking the compatibility of the BIOS updating file and the BIOS image file before the BIOS image file is divided.

14. The BIOS updating apparatus of claim 13, further comprising:
an update controlling module electrically connected to the component checking module and the dividing module for allowing the dividing module to divide the BIOS image file only when the BIOS updating file is compatible with the BIOS image file.

15. The BIOS updating apparatus of claim 14, further comprising:
a displaying module electrically connected to the update controlling module for displaying a notice message when the BIOS updating file is not compatible with the BIOS image file.

16. The BIOS updating apparatus of claim 14, further comprising:
a backing up module electrically connected to the update controlling module for backing up the BIOS image file when the BIOS updating file is compatible with the BIOS image file.

17. The BIOS updating apparatus of claim 1, further comprising:
an image checking module electrically connected to the packaging module for checking whether the updated image file is valid after the updated BIOS files are packaged.

18. The BIOS updating apparatus of claim 17, further comprising:
a displaying module electrically connected to the image checking module for displaying a notice message when the updated image file is not valid.
